(19) United States
(12) Patent Application Publication
(10) Pub. No.: US 2010/0061265 A1
(43) Pub. Date: Mar. 11, 2010

(54) Method of putting into operation a system for determining the power flows in a power distribution facility

(76) Inventor: Werner Becherer, Hemhofen (DE)

Correspondence Address: HARNESS, DICKEY & PIERCE, P.L.C., P.O.BOX 8910, RESTON, VA, 20195, US

(21) Appl. No.: 12/461,898

(22) Filed: Aug. 27, 2009

(30) Foreign Application Priority Data
Aug. 28, 2008 (DE) 10 2008 045 238.6

(51) Int. Cl. H04L 12/26

(52) U.S. Cl. 370/253

(57) ABSTRACT

A method is disclosed, in at least one embodiment, of putting into operation a system for determining the power flows by way of system components which are arranged at various places in a power distribution facility, in particular of an electrical power network, and are connected to one another by way of a communications network, it being possible for the characteristics of the electrical power network at these places and of the system components arranged at these places to differ from one another and the parameters and/or attributes of the system components to be respectively adapted to these differences in advance. A more efficient method is obtained if the system components that have the same relationship with their neighboring system components are respectively assigned to one and the same group, one system component of the group is selected and the other, nonselected system components of the group take over the parameters and/or attributes of the selected system component, the parameters and/or attributes being respectively adapted before the takeover in accordance with prescribed rules if characteristic of the electrical power network at the associated place or of the respectively associated system component differ from those of the selected system component.

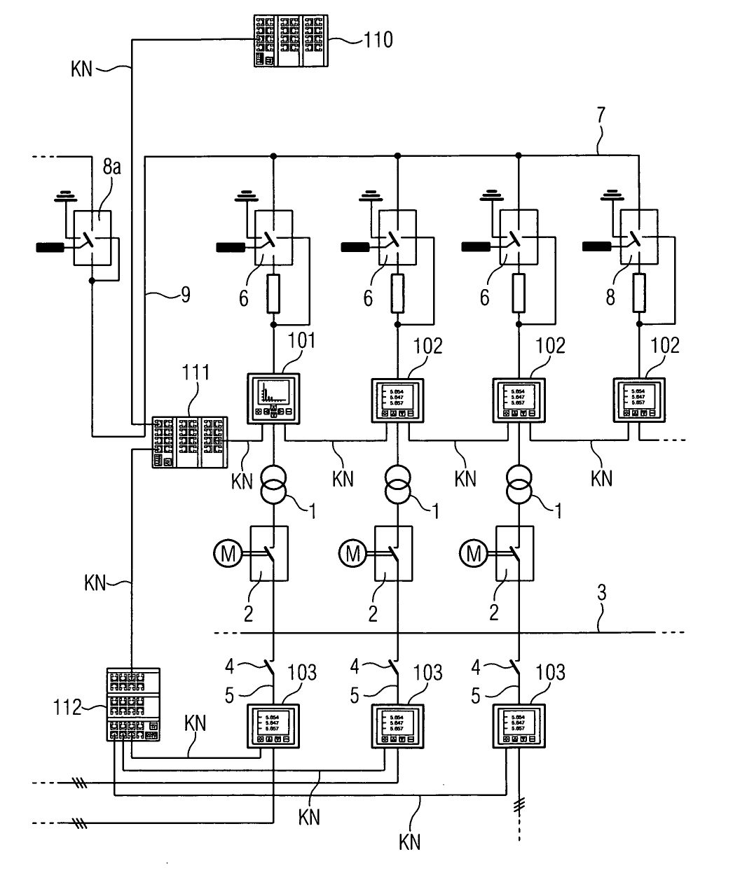

### PRIORITY STATEMENT

The present application hereby claims priority under 35 U.S.C. §119 on German patent application number DE 10 2008 045 238.6 filed Aug. 28, 2008, the entire contents of which are hereby incorporated herein by reference.

### FIELD

At least one embodiment of the invention generally relates to a method of putting into operation a system for determining the power distribution in an electrical power network.

### BACKGROUND

Systems for determining the power flows in a power distribution facility (for example an electrical power network) are known. Significant system components for the distribution of power in such a facility are circuit breakers, mechanical switches or load interrupter switches, miniature circuit breakers, fuse disconnectors or fuse-disconnector blocks. Further determining system components are power monitoring devices (PDMs), with the aid of which information on the electrical power network is acquired and stored, displayed and evaluated. This information includes in particular the root-mean-square value of the current that flows through the lines of the electrical power network, as a significant characteristic of the network.

Such a system is also referred to as a power monitoring and management system. It may comprise several hundred or even several thousand system components and is usually hierarchically organized, i.e. with superordinate and subordinate system components. Every system component may have additional intelligence, that is to say a microprocessor, memory and communication interfaces. The system components are connected to one another by means of a network for data communication. This applies in particular to the aforementioned PMDs.

In this case, superordinate system components are sometimes also capable of loading parameters (for example configuration parameters) and attributes (for example user settings) into the respectively subordinate system components and also reading them back from the latter. Furthermore, the superordinate system components can often also already interpret the parameters and attributes of the subordinate system components. The interpretation may be permanently programmed or take place by means of a corresponding device description.

It is disadvantageous in this case that it is nevertheless necessary for each individual system component to be put into operation individually, i.e. the user must set the appropriate parameters and attributes individually for each individual system component.

DE 101 01 805 A1, the entire contents of which are hereby incorporated herein by reference, already discloses a method of exchanging and replacing configured system components which are connected to a communications network and in which parameters and attributes are transferred from one system component to an exchanged or repaired system component by copying. This may take place, for example, with the aid of the method described in DE 103 09 168 A1, the entire contents of which are hereby incorporated herein by reference, for the implementation of simple nodes of a network.

### SUMMARY

In at least one embodiment, at least one problem addressed is that of providing an efficient method of putting into operation a system that serves for determining the power distribution in an electrical power network.

In at least one embodiment, at least one problem is solved by a method.

A solution, in at least one embodiment, provides that the system components that have the same relationship with their neighboring system components are respectively assigned to one and the same group, that one system component of the group is selected, that the other, nonselected system components of the group take over the parameters and/or attributes of the selected system component, the parameters and/or attributes being respectively adapted before the takeover in accordance with prescribed rules if characteristics or values of the characteristics of the electrical power network at the associated place or of the respectively associated system component differ from those of the selected system component. By way of example, the characteristics of the power network comprise voltage levels and/or minimum-maximum values and/or tolerance values for the power quality and/or plant identifiers and/or locational information (identifiers) and/or communication parameters (in particular the Gateway, DHCP and DNS servers or subnet mask).

In at least one embodiment, the method is therefore based on the concept that neighboring system components (superordinate, subordinate, located at parallel outgoing circuits) of the plant configuration can be adapted with the knowledge of neighboring system components and that this knowledge can also be appropriately passed on to newly added system components in the form of parameters and attributes (inherited). In this case, new parameters and attributes are generated from the existing parameters and attributes, to be precise by modification, for example by means of specified rules. The parameters and attributes in this case comprise static and plant-specific basic settings, such as the set language, user-defined error texts, secondary transformer currents as well as references and addresses relating to the communications network structure such as Gateways, DHCP and GMS servers.

However, these also include region-specific settings such as the limit values of warning and alarm messages, for example for overvoltage and undervoltage or tolerable time limits, the duration of the recordings, for example of load curves. However, they also include characteristics of the system components added, such as memory size, maximum sampling rate or MAC address (Ethernet address). The same applies to individual parameters of an individual system component, such as IP address, plant and location identifiers. The parameters and attributes can be modified according to rules that are specified by a manufacturer or a user or are supplemented by the latter. The following rules can be applied: static basic settings can be modified largely without, sometimes with, user queries.

Region-specific settings may be taken over with or without user queries and installed by way of characteristics of the system components, for example the duration of load curves can be dimensioned on the basis of memory size and number of the recording channels or the duration of recordings can be installed on the basis of memory size, number of recording channels and the sampling rate. It generally applies in particular that individual parameters of a system component can be formed from the combination of a number of items of information. For example, the IP address may be the next free address, taking into consideration the subnet mask. The previously most frequently used name patterns may be proposed as the plant and location identifiers.

A simple modification provides a proportional increase or decrease of the parameter or of the attribute.

In the case of a simple modification of attributes, to some extent the same characters are left at the same places, to be precise at those places that are respectively set the same.

The detection of the power distribution expediently takes place in the distribution node of the electrical power network by way of PMDs, all the PMDs that detect the outgoing circuits of the same distribution node respectively having the same relationship.

### BRIEF DESCRIPTION OF THE DRAWINGS

The invention is described in more detail below on the basis of an example embodiment.

The single FIGURE shows a detail of an electrical power network in which three transformers 1 are present.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The single FIGURE shows a detail of an electrical power network in which three transformers 1 are present. The transformers 1 are connected by way of motor-driven low-voltage switches 2 to a low-voltage distribution node 3 of the network, which is represented here as a solid line. The transformers 1 are connected by way of medium-voltage switches 6 to a medium-voltage distribution node 7.

In this case, an outgoing circuit passes from the distribution node 7 by way of a further medium-voltage switch 8, while a further outgoing circuit 9 of the distribution node 7 has a medium-voltage switch 8a.

At the distribution node 3, outgoing circuits 5 are respectively present by way of a separate low-voltage switch 4.

To determine the power flows, connected between the transformers 1 and the associated medium-voltage switches 6 are system components known as power monitoring devices 101, 102 (PMDs), which determine in particular the root-mean-square value of the current flowing through the associated medium-voltage switch 6 and, derived therefrom, determine the power. The measuring signal that is required for this and is proportional to the current is obtained by the PMDs 101, 102 by sensors that are not shown. A PMD 102 is also connected downstream of the medium-voltage switch 8. Furthermore, further PMDs 103 are provided downstream of the switches 4 in the outgoing circuits 5. The PMDs 102 and 103 are all configured the same, while the PMD 101 has a greater functional range, in particular more extensive display possibilities.

All the PMDs 101, 102 or 103 are connected to one another by way of a communications network KN (communication connections). This communications network KN has a superordinate central communications unit 110, to which subunits 111, 112 are connected. The FIGURE reveals that the subunit 112 is in this case not connected directly, but by way of the subunit 111.

The FIGURE further shows that the PMDs 101, 102 that are connected between the transformers 1 and the associated medium-voltage switch 6 are connected to one another in series, i.e. a PMD 101 or 102 is respectively connected to another neighboring PMD 101, 102 in the manner of a chain, the first PMD 101 in this chain additionally having a connection KN to the subunit 111.

The subunit 112 of the communications network is connected to PMDs 103. As can be seen, this connection is a point-to-point connection, i.e. each of these PMDs 103 is connected to the subunit 112 by way of a separate input.

There are therefore two networks, an electrical power network and a communications network KN. The PMDs 101, 102, 103, as part of the system components, are arranged at various places in the electrical power network, at which they pick off measuring signals proportional to the current by means of sensors. At the same time, these PMDs 101, 102, 103 are associated with the communications network KN, by way of which they are connected to one another technically in terms of communication.

The characteristics or values of the characteristics of the electrical power network may differ from one another at these places. The same applies to the PMDs 101, 102, 103 arranged at these places, and consequently assigned to or associated with these places, but with respect to their characteristics or the values of the characteristics of the communications network KN. And correspondingly, the parameters and/or attributes of the PMDs 101, 102, 103 relate to the characteristics or the values of the characteristics of the electrical power system and also of the communications network KN. Differences between the characteristics or the values of the characteristics therefore relate to both networks, it being self-evident that, for a single PMD 101, 102, 103, it is possible that there is only a single difference and that this merely concerns the communications network KN. Although the central communications unit 110 and the subunits 111, 112 are likewise system components that are associated with the communications network KN, they are not themselves arranged at any place in the electrical power network (for example by way of current sensors that access this place) or assigned to any place in some other way.

To put the system into operation, the central communications unit 110 must be appropriately set with respect to its parameters P and attributes A. The parameters P relate here to technical characteristics, while the attributes A relate more to the environment, the location and the communication.

By way of example, the following parameters P and attributes A are input in the communications unit 110:
A1: German (user language)
A2: 10000 (location identifier)
P1: yes (current transformer present?)
P2: 110% (alarm limit in % of the nominal voltage U_{N})
P3: 147.50.46.03 (IP address of the Gateway).

In this case, P3 is a parameter of the communications network KN, that is to say a communications parameter, while P1 and P2 are of the electrical power network, that is to say electrical parameters.

The subunit 111 is directly connected to the communications unit 110. The two are therefore directly neighboring in technical terms of communication, therefore have the same relationship with each other and are therefore assigned to the same group 1. The parameters P and the attributes A can be transferred from the communications unit 110 to the subunit 111. In this case, the attribute Al of the subunit 111 is taken over unchanged with “German” as the user language. A modification therefore does not take place. The attribute A2 is the location identifier; this is modified before the takeover, the modification here comprising raising the corresponding digit by 1, since the subunit 111 is connected directly to the communications unit 110. This location identifier may also be taken from an appropriately stored table which contains the concordance between the numerical identifiers and the location designation.

The parameter P1 remains at “yes”, since current transformers are likewise allowed. The nominal voltage U_{N} is the important network characteristic here, which was previously input (for example when requested). To modify P2, the nominal voltage U_{N} of the distribution node 7 (associated with the subunit 111) is then used, stored as parameter P4 in the subunit 111 once it has simply been multiplied by 110% according to the rule applying here (factor of 1.1). In the case of a nominal voltage U_{N} of 10 kV, 11 kV is therefore taken over here. The parameter P3 is taken over unchanged, since the IP address of the Gateway for both subunits 111, 112 is the same as that of the communications unit 110. The parameter added here, P4, for the current transformer ratio, is 100 (transformer ratio 100:1), that is to say a current of 100 A with a nominal voltage of 10 kV is transformed to 1 A.

All the parameters P1-P4 and the attributes A1-A2 are transferred unchanged to the PMDs 101, 102, since they are all connected to the outgoing circuits of the same distribution node 7, therefore are directly neighboring in technical terms of communication and so have the same relationship to one another. Furthermore, the distribution node 7 has a nominal voltage of 10 kV, which is the same for all the outgoing circuits of the distribution node 7 and consequently for all the PMDs 101, 102, since they are directly neighboring and so also have the same relationship to one another once again. They are therefore assigned to the same group 2.

The two subunits 111, 112 form the group 3, since they are directly neighboring and so have the same relationship to one another. The setting of the parameters P and attributes A of the subunit 112 takes place by taking over the parameters P1-P4 and the attribute A1 of the subunit 111 unchanged.

The PMDs 103 are connected to the outgoing circuits of the same distribution node 3, therefore are directly neighboring and so have the same relationship to one another.

Associated with the distribution node 3 is a nominal voltage of 400 V, which is the same for all the outgoing circuits of the distribution node 3 and consequently for all the PNDs 103. They are therefore assigned to the same group 4. Since the distribution node 3 with which this subunit 112 is associated has a nominal voltage of 400 V, before the takeover the parameter P4 must be newly calculated according to the rule 10 kV/400 V, that is multiplied by 100. The current transformer ratio here becomes 2500 (transformer ratio 2500:1). Furthermore, before the takeover the attribute A2 is modified in that the second digit of the location identifier is increased by one, that is to say to 12000. This location identifier can in turn also be taken from a corresponding table. The parameters P1-P3 and the attribute A1 are taken over by the PMDs 103 unchanged.

The other, nonselected system components of a group therefore always take over the parameters and/or attributes of the selected system component. A modification or adaptation of the parameters and/or attributes always takes place in each case before the takeover if characteristics or values of the characteristics of the electrical power network at the associated place or characteristics or values of the characteristics of the respectively associated system component, that is to say of the communications network KN, differ from those of the selected system component. At the same time, however, parameters and/or attributes of those system components that are themselves not arranged at any place in the electrical power network or assigned to such a place may also be taken over in the same way.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method of putting into operation a system for determining power flows in an electrical power network via system components arranged at various places in the electrical power network and connected to one another by way of a communications network, characteristics or values of the characteristics of the electrical power network at the places and of the system components arranged at the places differing from one another, and at least one of parameters and attributes of the system components respectively being adapted to the differences in advance, that the method comprising:
respectively assigning system components, that have the same relationship with neighboring system components, to one same group; and
selecting one system component of the group, wherein nonselected system components of the group take over the at least one of parameters and attributes of the selected one system component, the at least one of parameters and attributes being respectively adapted before the takeover in accordance with prescribed rules if characteristics or values of the characteristics of the electrical power network at the associated place or of the respectively associated system component differ from those of the selected system component.

2. The method as claimed in claim 1, wherein the network characteristics comprise at least one of
voltage levels, minimum-maximum values and tolerance values for the power quality, plant identifiers,
vocational information identifiers, and
communication parameters.

3. The method as claimed in claim 1, wherein the modification comprises a proportional increase or decrease of the parameter or of the attribute.

4. The method as claimed in claim 1, wherein the plant identifiers and the location identifiers comprise as attributes to some extent the same characters at the same places, which are respectively set the same.

5. The method as claimed in claim 1, wherein the detection of the power distribution takes place in distribution nodes of the electrical power network and wherein all the system components that detect the outgoing circuits of the same distribution node respectively have the same relationship.

6. The method as claimed in claim 2, wherein the communication parameters include Gateway, DHCP and DNS servers, or subnet mask.

7. The method as claimed in claim 2, wherein the modification comprises a proportional increase or decrease of the parameter or of the attribute.

8. The method as claimed in claim 2, wherein the plant identifiers and the location identifiers comprise as attributes to some extent the same characters at the same places, which are respectively set the same.

9. The method as claimed in claim 2, wherein the detection of the power distribution takes place in distribution nodes of the electrical power network and wherein all the system components that detect the outgoing circuits of the same distribution node respectively have the same relationship.

10. The method as claimed in claim 3, wherein the plant identifiers and the location identifiers comprise as attributes to some extent the same characters at the same places, which are respectively set the same.

11. The method as claimed in claim 3, wherein the detection of the power distribution takes place in distribution nodes of the electrical power network and wherein all the system components that detect the outgoing circuits of the same distribution node respectively have the same relationship.

12. The method as claimed in claim 4, wherein the detection of the power distribution takes place in distribution nodes of the electrical power network and wherein all the system components that detect the outgoing circuits of the same distribution node respectively have the same relationship.
